(19) United States
(12) Patent Application Publication
(10) Pub. No.: US 2023/0114582 A1
(43) Pub. Date: Apr. 13, 2023

(54) SMART CHECK-IN SERVICE

(71) Applicant: VMware, Inc., Palo Alto, CA (US)

(72) Inventor: Rohit Pradeep Shetty, Bangalore (IN)

(21) Appl. No.: 17/499,627

(22) Filed: Oct. 12, 2021

(51) Int. Cl. G06Q 10/10

(52) U.S. Cl. CPC G06Q 10/1095

(57) ABSTRACT

Systems and methods are described for providing check-in service that dynamically manages in-person meetings. In an example, the check-in service can receive a meeting request for a meeting of a first user with a second user at a location. The first user can request the meeting using a graphical user interface (“GUI”) or the check-in service can identify a meeting request based on a message sent from the first user to the second user. When the second user visits the location, the check-in service can send the meeting request to a user device of the second user. The second user can respond on the user device by accepting, rejecting, or postponing the meeting request. If postponed, the check-in service can place the meeting request in a queue and resend the meeting request when the second user next visits the location. If accepted, the check-in service can notify the first user.

### BACKGROUND

Advances in technology have sparked a shift in many working cultures from a primarily in-office model to a telecommute or hybrid model. More and more employees are working from home while coming into the office less frequently. Most industries do, however, still require some degree of in-person meetings. The shift away from in-office work presents a challenge of predicting when colleagues will be attending office in-person or when they are working remotely.

Currently, employees can publish calendar slots (such as with a shared calendar) for days on which they might visit the office, and other employees can book slots or drop by for a discussion based on the calendar. But this requires that each employee's calendar be up to date, which is often not the case. Moreover, an employee's schedule can frequently change. Even if the employee keeps his or her calendar up to date, others must frequently check the employee's calendar to know whether the employee is available or not. Additionally, when some employees come into the office, they can be inundated with people wanting to meet in person, which can make it difficult to accomplish other responsibilities in the office.

As a result, a need exists for dynamically coordinating in-person meetings in today's hybrid work culture.

### SUMMARY

Examples described herein include systems and methods for providing a check-in service that dynamically manages in-person meetings. The check-in service can determine when a first user (hereinafter also referred to as “the User A”) wants to meet in-person with a second user (hereinafter also referred to as “the User B”) at a location. In an example, a check-in service can receive a meeting request. The meeting request can come from a first user device that is associated with the User A and indicate a desire to meet in-person with the User B. The meeting request can include parameters that indicate the requestor, the requestee, a location, a timeframe, and an urgency level.

In one example, the User A can create the meeting request using a graphical user interface (“GUI”) on the first user device. The GUI can include fields related to the meeting parameters described above. For example, the User A can indicate who he or she wants to meet with, where the meeting should occur, in what timeframe the meeting can occur, and how urgent the meeting is. The first user device can create a data file with the parameters and send the data file to the check-in service.

In another example, the check-in service can identify a meeting request based on a message sent from the User A to the User B, such as an email or instant message. For example, the check-in service can have access to read and analyze messages sent between users to search for meeting requests. In one example, the check-in service can analyze the text using one or more natural language processing (“NLP”) techniques, such as classification predictive modeling, keyword extraction, and named entity recognition. In another example, the check-in service can apply the NLP techniques using a machine learning (“ML”) algorithm that is trained to identify a request to meet and then extract and categorize relevant details. For example, the check-in service can extract details corresponding to the parameters described above. The check-in service can then create a data file with the meeting parameters.

In an example, the check-in service can add the meeting request to a queue associated with the User B. The check-in service can store meeting requests for the User B in one or more queues based on the requested times and locations of the requests. When the check-in service detects that the User B arrived at a location designated in a meeting request and within the timeframe specified in the meeting request, the check-in service can send that meeting request to a second user device that is associated with the User B. The meeting request can be sent as a notification, in an example.

Upon receiving the meeting request, the second user device can display the meeting request, which the User B can then review. The displayed meeting request can include response options for the User B. For example, the User B can accept, reject, or postpone the meeting request. If the User B accepts a meeting request, the user device B can notify the check-in service, and the check-in service can in turn send a notification to the first user device. In one example, the check-in service can also provide meeting time options based on the calendars of the User A and the User B.

If the User B rejects the meeting request, then the check-in service can delete the request. In one example, no notification is sent to the first user device when the request is rejected. In another example, the User B can provide an explanation for rejecting the request, which can be sent to the first user device.

If the User B postpones the meeting request, then the check-in service can add the meeting request back to the queue. The check-in service can send the meeting request again the next time the User B goes to the location. In one example, when postponing a meeting request, the User B can select a length of time for the meeting request to be postponed before another notification is sent to the second user device.

The examples summarized above can each be incorporated into a non-transitory, computer-readable medium having instructions that, when executed by a processor associated with a computing device, cause the processor to perform the stages described. Additionally, the example methods summarized above can each be implemented in a system including, for example, a memory storage and a computing device having a processor that executes instructions to carry out the stages described.

Both the foregoing general description and the following detailed description are exemplary and explanatory only and are not restrictive of the examples, as claimed.

### BRIEF DESCRIPTION OF THE DRAWINGS

FIG. 1 is an illustration of an example system for providing a check-in service.

FIG. 2 is a flowchart of an example method for providing a check-in service.

FIG. 3 is a sequence diagram of an example method for providing a check-in service.

FIG. 4 is a sequence diagram of another example method for providing a check-in service.

### DESCRIPTION OF THE EXAMPLES

Reference will now be made in detail to the present examples, including examples illustrated in the accompanying drawings. Wherever possible, the same reference numbers will be used throughout the drawings to refer to the same or like parts.

Systems and methods are described for providing check-in service that dynamically manages in-person meetings. In an example, the check-in service can receive a meeting request for a meeting of a first user with a second user at a location. The first user can request the meeting using a graphical user interface (“GUI”) or the check-in service can identify a meeting request based on a message sent from the first user to the second user. When the second user visits the location, the check-in service can send the meeting request to a user device of the second user. The second user can respond on the user device by accepting, rejecting, or postponing the meeting request. If postponed, the check-in service can place the meeting request in a queue and resend the meeting request when the second user next visits the location. If accepted, the check-in service can notify the first user. If rejected, the check-in service can delete the meeting request.

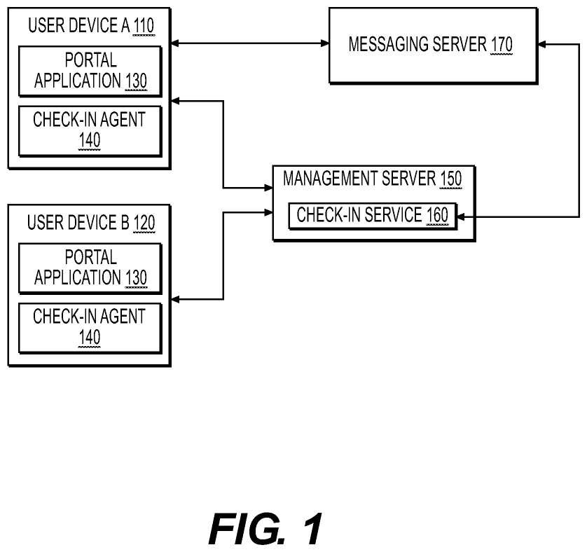

FIG. 1 is an illustration of an example system for providing a check-in service 160. The check-in service 160 can be a service that handles in-person meeting requests between users. The check-in service 160 can be hosted on a server or cloud-computing platform. In one example, the check-in service 160 can be provided as software as a service (“SaaS”). In another example, the check-in service 160 can be a service provided as part of a Unified Endpoint Management (“UEM”) system, which can be any system for managing a group of user devices. For example, a management server 150, or another server in a UEM system, can host the check-in service 160. The management server 150 can be a single server or a group of servers, including multiple servers implemented virtually across multiple computing platforms.

In an example, a management server 150 can be responsible for managing user devices enrolled in a UEM system. User devices A 110 and B 120 are two examples of such enrolled user devices. The user device A 110 is used throughout to describe the user device of a user requesting a meeting (User A), and the user device B 120 is used throughout to describe the user device of a user with whom a meeting is requested (User B). In one example, the management server 150 can manage the user devices A 110, B 120 by sending management instructions to a portal application 130 installed on the user devices A 110, B 120. The portal application 130 can be a stand-alone application, part of an enterprise application, or part of an operating system of the user devices A 110, B 120. In some examples, the portal application 130 can provide access to a library of applications available to a user, such as by displaying application icons and, when an icon is selected by the user, providing single-sign-on authentication for that application on behalf of the user.

In an example, the portal application 130 can be responsible for ensuring that the user devices A 110, B 120 are up to date with compliance and security settings prior to accessing enterprise data and resources. The portal application 130 can communicate with the management server 150, allowing UEM management of the user devices A 110, B 120 based on compliance and security settings at the management server 150. The portal application 140 can enforce compliance at the user devices A 110, B 120, such as by wiping enterprise data when compliance standards are not met. Example compliance standards can include ensuring a device is not jailbroken, that particular encryption standards are used in enterprise data transmission, that the device does not have certain blacklisted applications installed or running, and that the device is located within a geofenced area when accessing certain enterprise resources. In one example, the user devices A 110, B 120 can access enterprise or UEM resources through the management server 150.

In an example, the user devices A 110, B 120 can include a check-in agent 140. The check-in agent 140 can be an application that executes on the user devices A 110, B 120 in some examples. In other examples, the check-in agent 140 can be a feature within another application executing on the user devices A 110, B 120, such as the portal application 130 or a management agent. The check-in agent 140 can communicate with the check-in service 160 to manage meeting requests between users of the user devices A 110, B 120. In an example, the check-in service 160 and check-in agent 140 can operate in multiple modes. For example, the check-in agent 140 can include a standalone mode where the User A can create a meeting request. In one example, check-in agent 140 can provide a GUI where the User A can request a meeting and provide details using various GUI fields. For example, the User A can specify a timeframe (such as the next two days or in the next week), indicate an urgency level of the meeting, describe the nature of the meeting, provide any attachments or links, and identify any favorable time slots.

In an example, the check-in service 160 can have access to read and analyze messages that pass through, or are received at, the messaging server 170. The messaging server 170 can be a server that hosts a messaging application or receives or transmits messages. For example, the messaging server 170 can be an email server, a messaging server, or a notification server. In one example, the messaging server 170 can be managed by the UEM system, such as by being managed or controlled by the management server 150. The check-in service 160 can analyze messages passing through or stored on the messaging server 170 to identify any in-person meeting requests. In an example, the check-in service 160 can do this by applying one or more NLP techniques, such as classification predictive modeling, keyword extraction, and named entity recognition. The check-in service 160 can identify the need for a meeting based on the text and extract relevant information, such as a location, timeframe, meeting reason, and an urgency level. In one example, the check-in service 160 can analyze the test by applying an ML model trained to identify a desire to meet in-person and extract relevant information. In some examples, the messaging server 170 performs the analysis instead of, or in addition to, the check-in service 160 performing the analysis. For example, the messaging server 170 can include a filter or software module for performing any NLP techniques or applying ML models to identify meeting requests.

In one example, the check-in agent 140 can include an integrated mode where the check-in agent 140 is integrated into another application. For example, the check-in agent 140 can be integrated into a messaging application as a plugin or software development kit (“SDK”). The messaging application can be associated with the messaging server 170, in an example. Some examples of such applications can include the portal application 130, an email application, an instant messaging application, and a conferencing application. In an example, in lieu of, or in parallel with, the check-in service 160 analyzing messages at the server level, the check-in agent 140 can analyze text at the application level to search for any indication that the User A wants to meet with the User B. In an example, the check-in agent 140 can analyze text in the application using the same NLP techniques described above regarding the check-in service 160.

Although examples herein describe the check-in agent 140 as being integrated into an application and identifying a meeting request based on text from the User A, in some examples these actions can be performed by the check-in service 160. For example, the check-in service 160 can have access to data on application servers and can analyze communications from the User A at the server level to identify meeting requests rather than at the user device level.

In an example, the check-in agent 140 can create a data file that includes parameters for the meeting request. The parameters can be based on input received through a GUI of the check-in agent 140 or based on data extracted from a communication from the User A to the User B. The data file can be any kind of data file that can be used to interpret the meeting parameters, such as an Extensible Markup Language (“XML”) file, a JavaScript Object Notation (“JSON”) file, or a “Yet Another Markup Language” or “YAML Ain′t Markup Language” (“YAML”) file. The check-in agent 140 can send the data file to the check-in service 160. This can be done using a Hypertext Transfer Protocol (“HTTP”) call or an Application Programming Interface (“API”) call, as some examples.

In one example, the check-in service 160 can have access to the schedules of users in the UEM system. For example, the UEM system can utilize a calendar application that keeps track of the users' schedules. The check-in service 160 can provide certain information from a user's schedule to other users. For example, if the User A wants to meet with the User B, the check-in agent 140 on the user device A 110 can request the schedule of the User B from the check-in service 160. The check-in service 160 can retrieve the User B's schedule and send it to the check-in agent 140 on the user device A 110. The check-in agent 140 can be configured to show when the User B has openings in his or her schedule. This can include displaying specific days or times when the User B is scheduled to be at a certain location, such as an office where the User A works.

In an example, when the User A creates a meeting request with the check-in agent 140, or alternatively when the check-in agent 140 detects a meeting request, the check-in service 160 can store the meeting request in a queue associated with the User B. The meeting request can remain in the queue until the check-in service 160 detects (or is otherwise informed of) the User B at the location. The check-in service 160 can detect the User B at the location using various methods. In one example, the check-in service 160 can detect a login using the User B's credentials from a computing device at the location. In another example, the check-in service 160 can receive a notification that the user device B 120 is at the location. For example, the check-in agent 140 on the user device B 120 can send global positioning system (“GPS”) information to the check-in service 160, the user device B 120 can connect to a local network at the location, or a device at the location can detect the user device B 120 using BLUETOOTH Low Energy (“LE”) or any other near-field communication methods. In still another example, the User B can scan an identification (“ID”) card to access the location, and a notification can be sent to the check-in service 160.

In an example, after the User B is the detected at the location, the check-in service 160 can send all queued meeting requests for the User B at that location to the user device B 120. The user device B 120 can display one or more notifications corresponding to the meeting requests, and the User B can choose how and whether to respond. In one example, the notification can be handled by the check-in agent 140. In another example, the check-in agent 140 can provide multiple response options, including, for example, to accept a request, reject a request, and postpone a request. If the User B accepts a request, the check-in service 160 can be configured to send a notification to the User Device A 110, either directly or through the management server 150, check-in service 160, or messaging server 170. In one example, the check-in service 160 can add the in-person meeting to the calendars of both Users A and B.

If the User B rejects a request, the check-in service 160 can be configured to perform one of various possible actions. In one example, the check-in service 160 can simply delete the meeting request from the User A without sending any notification regarding the deletion. In another example, the check-in agent 140 on the user device B 120 can allow the User B to provide a reason for rejecting the meeting, and the reason can be sent in a rejection notification to the user device A 110. If the User B postpones the meeting request, the request can be put back into the queue for the User B. In this example, no notification is sent to the user device A 110, and the check-in service 160 can send another notification of the meeting request to the user device B 120 the next time the user device B 120 checks in at the location.

In one example, prior to sending a meeting request to the user device B 120, the check-in service 160 can verify that the User A is also at the location. This can prevent the User B from being notified of a meeting request for that day if the User A is not available to meet. The check-in service 160 can verify that User A is at the location using any of the methods described above regarding the User B. In another example, before sending a meeting request, the check-in service 160 can ensure that both the User A and the User B are available at the same time, such as by accessing calendar data for both users and comparing the data to identify a block of time that is longer than a threshold amount, such as 20 minutes. For example, the User B does not need to be notified of a meeting request if there is not an available time for the User A and the User B to meet. In either of these cases, the meeting request can remain in the queue until both the User A and the User B are at the location and have a matching opening in their schedules.

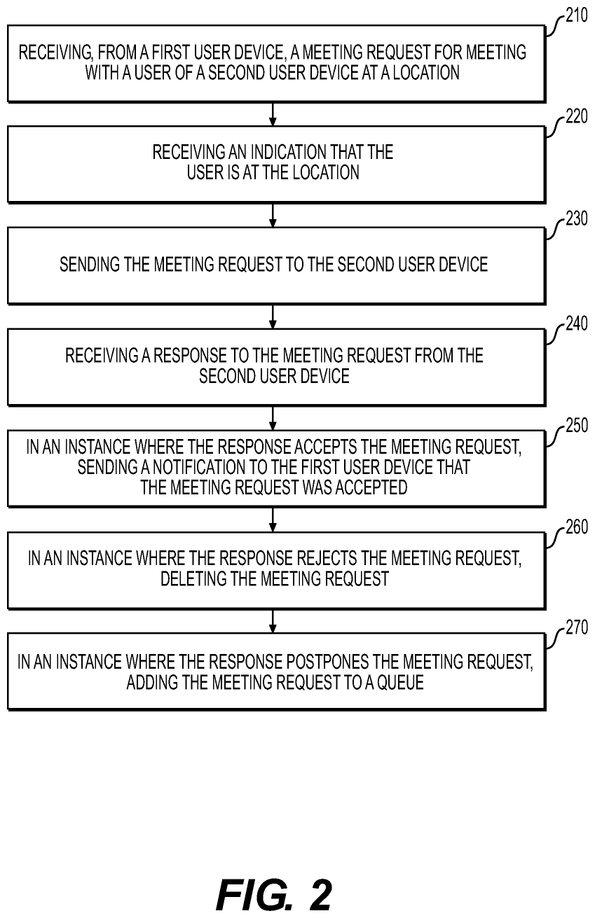

FIG. 2 is a flowchart of an example method for providing a smart check-in service. At stage 210, the check-in service 160 can receive, from the user device A 110, a request for a meeting with the User B at a location. In one example, the request can be created by the User A with a GUI provided by the check-in agent 140. The GUI can allow the User A to select another user and provide details for the requested meeting. For example, the User A can specify a timeframe (such as the next two days or in the next week), specify a location, indicate an urgency level of the meeting, describe the nature of the meeting, provide any attachments or links, and identify any favorable time slots.

In one example, the meeting request can be created based on a communication sent from the User A to the User B, such as an email or instant message, including a message sent on a collaboration application such as SLACK or MICROSOFT TEAMS. The check-in agent 140 can analyze text provided by the User A to search for any indication that the User A wants to meet with the User B. In one example, the check-in agent 140 can identify a meeting request by applying one or more NLP techniques, such as classification predictive modeling, keyword extraction, and named entity recognition. The check-in agent 140 can also extract relevant information, such as a timeframe, meeting reason, and urgency level.

As an example, the User A can send a message to the User B that reads “Hey Mike, Free to meet this week in person. Wanted to go over the Sales estimates. It's a bit pressing.” The check-in agent 140 can identify this as a request to meet based at least on the portion that reads “free to meet this week in person.” The check-in agent 140 can categorize portions of the text by applying NLP techniques. In one example, the check-in agent 140 can categorize the message into predetermined categories, such as the timeframe, meeting purpose, and urgency level. For example, “this week” can be assigned to the timeframe category, “go over the Sales estimates” can be assigned to the meeting purpose category, and “it's a bit pressing” can be assigned to the urgency category. The check-in agent 140 can also assign values to each category. For example, based on their corresponding portions of text, the timeframe category can be assigned a value corresponding to the current calendar week, the meeting purpose category can be assigned a value corresponding to reviewing sales estimates, and the urgency category can be assigned a value corresponding to elevated urgency.

In an example, the check-in agent 140 can create a data file that includes parameters for the meeting request. The data file can be any kind of data file that can be used to interpret the meeting parameters, such as an XML file, a JSON file, or a YAML. The check-in agent 140 can send the meeting request data file to the check-in service 160. In one example, the check-in service 160 can store the meeting request in a queue for the User B. The check-in service 160 can send queued meeting requests to the user device B 120 when the User B arrives at a corresponding location.

At stage 220, the check-in service 160 can receive an indication that the User B is at the location associated with the meeting request from the User A. Such an indication can be made based on various events occurring. In one example, the check-in service 160 can detect a login using the User B's credentials from a computing device at the location. In another example, the check-in service 160 can receive a notification that the user device B 120 is at the location. For example, the check-in agent 140 on the user device B 120 can access GPS location information on the user device B 120 and notify the check-in service 160 when the GPS information indicates that the user device B 120 is at the location. In one example, the check-in service 160 can be notified when user device B 120 connects to a local network at the location, such as an on-premises WI-FI network. In another example, a device at the location can detect a BLUETOOTH LE signal emitted by the user device B 120 and notify the check-in service 160. In still another example, the User B can scan an ID card to access the location, and a notification can be sent to the check-in service 160.

At stage 230, the check-in service 160 can send the meeting request to the user device B 120. In one example, the meeting request can be sent as a notification. As an example, the check-in service 160 can send a meeting request notification to a push notification server that then pushes the notification to the user device B 120. The check-in service 160 can send the meeting request using other means in addition to, or in lieu of, a notification, such as an email, a text message, or an instant message. In one example, the check-in service 160 can send the meeting request to the check-in agent 140 on the user device B 120 using an API call. The meeting request can include details about the request, such as who is requesting the meeting, the timeframe in which the requesting user would like to meet, the purpose of the meeting, and the urgency level.

In an example, the user device B 120 can display the meeting request. In one example, the meeting request can be displayed as a notification on the user device B 120 associated with the portal application 130. In another example, the meeting request can be displayed within a GUI of the portal application 130 when the User B loads the portal application 130.

In an example, the check-in service 160 can send meeting requests whose parameters are met when the User B arrives at a location. For example, the check-in service 160 can queue multiple meeting requests for the User B that originate from various users at various locations. As discussed previously, the meeting requests can include timeframe and location parameters. When the User B arrives at a location, the check-in service 160 can send all the queued meeting requests that designate the location and have a timeframe that the User B's arrival time falls within. For example, if the User A requests a meeting with the User B at a different location than the location that the User B arrives at, then the check-in service 160 will not send that meeting request at that time. Also, if the User A requests a meeting with the User B next month, but the User B arrives before the beginning of the next month, the check-in service 160 will not send that meeting request. In other words, the check-in service 160 can send meeting requests relevant to the User B's location and arrival time.

In one example, the User B can view and respond to pending meeting requests before the User B goes to the location. For example, the portal application 130 can include a feature where the User B can view all queued meeting requests, and the User B can respond without waiting until the User B goes to the location. As an example, if the User B has a meeting request from the User A, but the User B will not be at the location of the meeting request during the timeframe of the request, the User B can reject the meeting request and notify the User A accordingly. In another example, the User B can accept a request before arriving at the location when the User B knows for certain that he or she will be at the location. In one example, the check-in agent 140 can allow the User B to indicate when he or she will be at the location, and the check-in service 160 can notify the user device A 110 so that the User A can plan accordingly. In such an example, the check-in service 160 can also notify the user device A 110 once the check-in service 160 receives an indication that the User B is at the location.

At stage 240, the check-in service 160 can receive a response to the meeting request from the user device B 120. For example, the meeting request displayed on the user device B 120 can include response options for the User B. For example, the displayed meeting request can allow the User B to accept, reject, or postpone a meeting request. The response options can also allow the User B to add a message for the User A. For example, the User B can accept the request and specify time and place to meet, or the User B can reject the request and provide an explanation for why.

At stage 250, in an instance where the response accepts the meeting request, the check-in service 160 can send a notification to the user device A 110 that the user accepted the meeting request. The notification can include any information provided by the User B, such as when and where to meet.

In one example, the check-in service 160 can compare the calendars of the Users A and B and propose one or more meeting times when the Users A and B show available. The User B can select one or more times, and the notification sent to the user device A 110 can display the selected times. The User A can then select one of the times, and the check-in service 160 can update the calendars of both Users A and B accordingly. In one example, the check-in service 160 can also allow both Users A and B to choose and confirm a meeting location. In another example, the check-in service 160 can inform the User B of the location of the User A when known. For example, if the User A accesses a temporary cubicle or meeting room, the check-in service 160 can send the location of the cubicle or meeting room to the user device B 120. Alternatively, the check-in service 160 can notify the User A of the User B's location. For example, if the Users A and B do not set a time to meet, the check-in service 160 can send any known locations of the User B to the user device A 110, such as when the User B accesses a cubicle or meeting room.

At stage 260, in an instance where the response rejects the meeting request, the check-in service 160 can delete the meeting request. For example, the check-in agent 140 can remove the meeting request from the display of the user device B 120, and the check-in service 160 can remove the meeting request from the queue. In one example, this can be done without notifying the User A. In another example, the User B can choose whether to notify the User A. In still another example, the User B can include a response with the rejection, such as an explanation for why the meeting request was rejected, and the check-in service 160 can send a notification of the rejection that includes the User B's response.

At stage 270, in an instance where the response postpones the meeting request, the check-in service 160 can add the meeting request back to the queue. For example, if the User B wants to meet with the User A but is unable to do so on that particular day, then the User B can select to postpone the meeting request. When a meeting request is re-added to the queue, the check-in service 160 can treat the meeting request as any other request in the queue. For example, the check-in service 160 can send the meeting request to the user device B 120 again the next time the User B arrives at the location. In one example, the User B can indicate how long to postpone the meeting request. As an example, the User A can request to meet with the User B at the location within the next month. The User B can arrive a few days later and receive the meeting request notification. The User B, knowing that he or she plans to come to the location every day for that week, but wants to meet with the User A the following week, can select to postpone the meeting request for a week or until the following week. After the indicated postponement period has passed, the check-in service 160 can begin again sending the meeting notification to the user device B 120 each time the User B goes to the location.

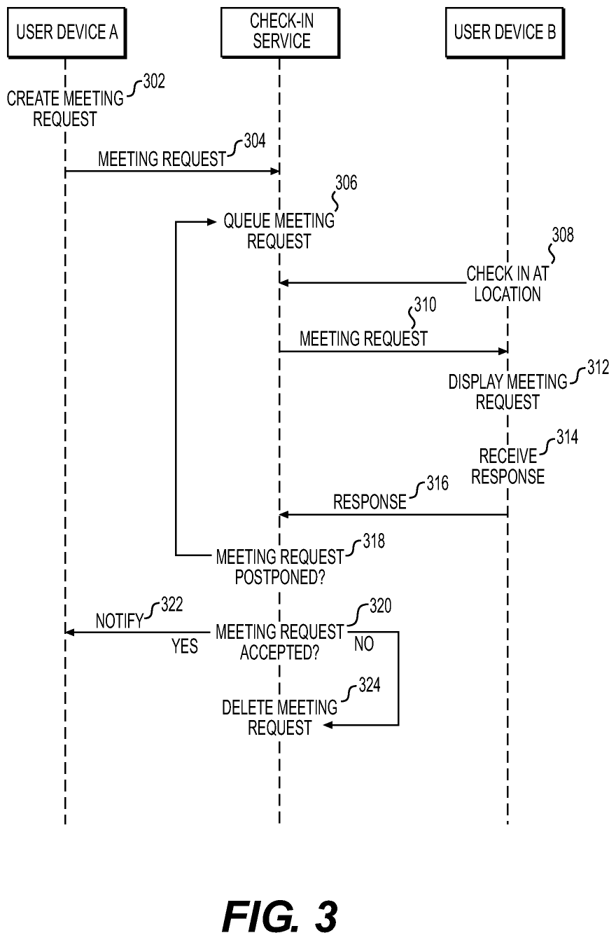

FIG. 3 is a sequence diagram of an example method for providing a check-in service 160. At stage 302, the user device A 110 can create a meeting request. For example, the User A can create a meeting request by using a GUI provided by the check-in agent 140. The GUI can allow the User A to select another user and provide details for the requested meeting. For example, the User A can specify a timeframe (such as the next two days or in the next week), specify a location, indicate an urgency level of the meeting, describe the nature of the meeting, provide any attachments or links, and identify any favorable time slots.

At stage 304, the user device A 110 can send the meeting request to the check-in service 160. In one example, the check-in agent 140 executing on the user device A 110 can create a data file based on the details provided by the User A. For example, each field in the GUI can map to a parameter for the meeting request, and the check-in agent 140 can create a data file with those parameters. The data file can be any kind of data file that can be used to interpret the meeting parameters, such as an XML file, a JSON file, or a YAML file. In an example, the user device A 110 can send the meeting request using an HTTP or API call, as some examples.

At stage 306, the check-in service 160 can queue the meeting request. For example, the check-in service 160 can store the meeting request in a queue associated with the User B. The meeting request can remain in the queue until the check-in service 160 detects the User B at the location specified in the meeting request.

At stage 308, the user device B 120 can check in at the location identified in the meeting request. A check-in at the location can include any method in which the check-in service 160 can detect or be notified that the User B is at the location. As some examples, the User B can log into a computing device at the location using his or her credentials, the User B can access the location using a key card, a device at the location can detect the user device B 120 using BLUETOOTH LE, the user device B 120 can connect to a WIFI network at the location, or the check-in agent 140 on the user device B 120 can notify the check-in service 160 when GPS data of the user device B 120 indicates that the user device B 120 is at the location.

At stage 310, the check-in service 160 can send the meeting request to the user device B 120. In one example, the check-in service 160 can send the meeting request based on the User B's arrival satisfying the parameters of the meeting request. For example, check-in service 160 can send the meeting request if the User B's arrival matches the location and timeframe of the meeting request. In an example, the check-in service 160 can send the meeting request as a data file, such as an XML, YAML, or JSON file. In another example, the check-in service 160 can send the meeting request using an API call. In still another example, the check-in service can send the meeting request as a notification to a push notification server, and the push notification server can push the meeting request notification to the user device B 120.

At stage 312, the user device B 120 can display the meeting request. In one example, the meeting request can be displayed as a notification on the user device B 120 associated with the portal application 130. In another example, the meeting request can be displayed within a GUI of the portal application 130 when the User B loads the portal application 130.

At stage 314, the user device B 120 can receive a response regarding the meeting request. For example, the meeting request displayed on the user device B 120 can include response options for the User B. For example, the displayed meeting request can allow the User B to accept, reject, or postpone a meeting request. The response options can also allow the User B to add a message for the User A. For example, the User B can accept the request and specify time and place to meet, or the User B can reject the request and provide an explanation for why. At stage 316, the user device B 120 can send the response to the check-in service 160. For example, the user device B 120 can send a data file, such as an XML, YAML, or JSON file that includes the response.

At stage 318, the check-in service 160 can determine whether the meeting request was postponed. For example, if the User B wants to meet with the User A but is unable to do so on that particular day, then the User B can select to postpone the meeting request. If the User B selects this option, then the check-in service 160 can add the meeting request back to the queue and the method can return to stage 306. The check-in service 160 can send the meeting request to the user device B 120 again when the User B next checks into the location.

At stage 320, the check-in service 160 can determine whether the meeting request was accepted based on input from the User B. If so, the method can proceed to stage 322 where the check-in service 160 can notify the user device A 110. The notification can include any information provided by the User B, such as when and where to meet. In one example, the check-in service 160 can compare the calendars of the Users A and B and propose one or more meeting times when the Users A and B show available. The User B can select one or more times, and the notification sent to the user device A 110 can display the selected times. The User A can then select one of the times, and the check-in service 160 can update the calendars of both Users A and B accordingly. In one example, the check-in service 160 can also allow both Users A and B to choose and confirm a meeting location.

If the User B rejected meeting request, the method can proceed from stage 320 to stage 324 where the check-in service 160 can delete the meeting request. For example, the check-in agent 140 can remove the meeting request from the display of the user device B 120, and the check-in service 160 can remove the meeting request from the queue. In one example, this can be done without notifying the User A. In another example, the User B can choose whether to notify the User A. In still another example, the User B can include a response with the rejection, such as an explanation for why the meeting request was rejected, and the check-in service 160 can send a notification of the rejection that includes the User B's response.

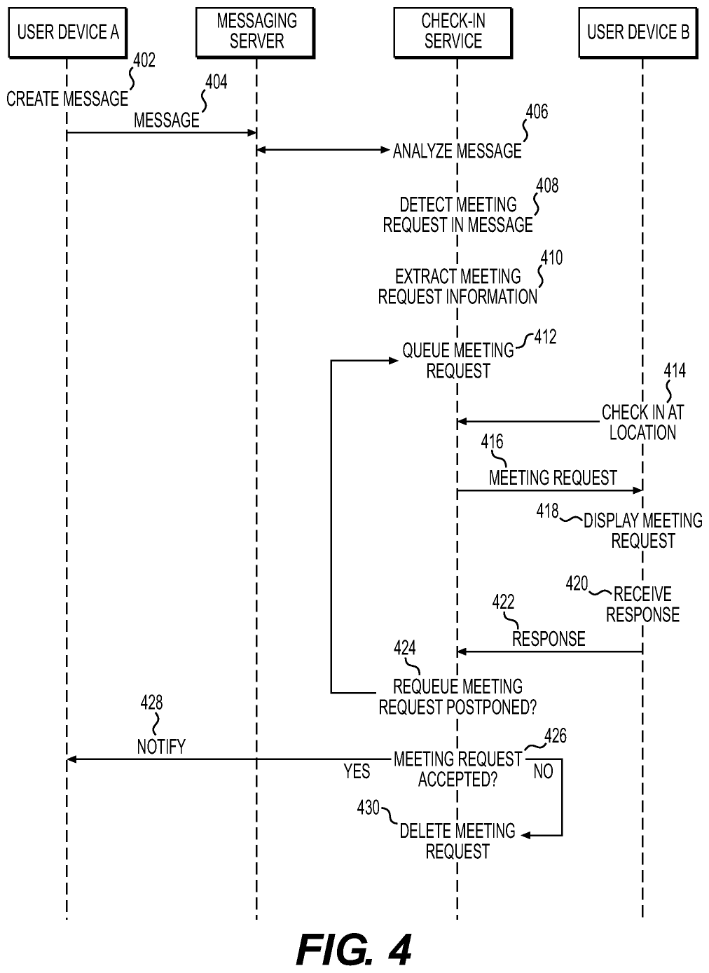

FIG. 4 is a sequence diagram of another example method for providing a smart check-in service. At stage 402, the user device A 110 can create a message. For example, the User A can create an email, instant message, or other type of message on the user device A 110. The message can be addressed to the User B. For example, the User A can draft an email addressed to the User B's email address or the User A can send an instant message to the User B using an instant messaging platform. At stage 404, the user device A 110 can send the message to the messaging server 170, either directly or by being routed through one or more other servers or devices. The messaging server 170 can be a server that hosts or manages messages on the messaging platform.

At stage 406, the check-in service 160 can analyze the message. In an example, analyzing the message can include applying one or more NLP techniques to text in the message, such as classification predictive modeling, keyword extraction, and named entity recognition. In one example, the check-in service 160 can apply an ML model that is trained to identify a request for an in-person meeting and extract relevant information.

At stage 408, the check-in service 160 can detect a meeting request in the message. For example, the check-in service can identify words or phrases in the message that indicate a desire for an in-person meeting between the User A and User B. Examples of such text can include “I want to meet,” “free to meet,” or “let's get together.”

At stage 410, check-in service 160 can extract meeting request information from the message. The meeting request information can include any information relevant to an in-person meeting. In an example, the check-in service 160 can categorize the meeting request information using predetermined categories such as the timeframe, meeting purpose, and urgency level. In one example, the check-in agent 140 can attempt to identify information for a category if it is unable to identify any text in the message relevant to that category. For example, if the User A does not specify a location, the check-in agent 140 can retrieve and use an office location where the User A usually works.

In one example, the check-in service 160 can create a data file that includes parameters of the meeting request. The data file can be any file type that can provide such parameters, such as an XML file, a JSON file, or a YAML file. The parameters can be based on the categories described above, in an example.

At stage 412, the check-in service 160 can queue the meeting request. For example, the check-in service 160 can store the meeting request in a queue associated with the User B. The meeting request can remain the queue until the check-in service 160 detects the User B at the location specified in the meeting request.

At stage 414, the user device B 120 can check in at the location. A check-in at the location can include any method in which the check-in service 160 can detect or be notified that the User B is at the location. As some examples, the User B can log into a computing device at the location using his or her credentials, the User B can access the location using a key card, a device at the location can detect the user device B using BLUETOOTH LE, the user device B 120 can connect to a WIFI network at the location, or the check-in agent 140 on the user device B 120 can notify the check-in service 160 when GPS data of the user device B 120 indicates that the user device B 120 is at the location.

At stage 416, the check-in service 160 can send the meeting request to the user device B 120. In one example, the check-in service 160 can send the meeting request based on the User B's arrival satisfying the parameters of the meeting request. For example, check-in service 160 can send the meeting request if the User B's arrival matches the location and timeframe of the meeting request. In an example, the check-in service 160 can send the meeting request as a data file, such as an XML, YAML, or JSON file. In another example, the check-in service 160 can send the meeting request using an API call. In still another example, the check-in service can send the meeting request as a notification to a push notification server, and the push notification server can push the meeting request notification to the user device B 120.

At stage 418, the user device B 120 can display the meeting request. In one example, the meeting request can be displayed as a notification on the user device B 120 associated with the portal application 130. In another example, the meeting request can be displayed within a GUI of the portal application 130 when the User B loads the portal application 130.

At stage 420, the user device B 120 can receive a response for the meeting request. For example, the meeting request displayed on the user device B 120 can include response options for the User B. For example, the displayed meeting request can allow the User B to accept, reject, or postpone a meeting request. The response options can also allow the User B to add a message for the User A. For example, the User B can accept the request and specify time and place to meet, or the User B can reject the request and provide an explanation for why. At stage 422, the user device B 120 can send the response to the check-in service 160. For example, the user device B 120 can send a data file, such as an XML, YAML, or JSON file that includes the response.

At stage 424, the check-in service 160 can determine whether the meeting request was postponed. For example, if the User B wants to meet with the User A but is unable to do so on that particular day, then the User B can select to postpone the meeting request. If the User B selects this option, then the check-in service 160 can add the meeting request back to the queue and the method can return to stage 412. The check-in service 160 can send the meeting request to the user device B 120 again when the User B next checks into the location.

At stage 426, the check-in service 160 can determine whether the meeting request was accepted based on input from the User B. If so, the method can proceed to stage 428 where the check-in service 160 can notify the user device A 110. The notification can include any information provided by the User B, such as when and where to meet. In one example, the check-in service 160 can compare the calendars of the Users A and B and propose one or more meeting times when the Users A and B show available. The User B can select one or more times, and the notification sent to the user device A 110 can display the selected times. The User A can then select one of the times, and the check-in service 160 can update the calendars of both Users A and B accordingly. In one example, the check-in service 160 can also allow both Users A and B to choose and confirm a meeting location.

If the User B rejected the meeting request, the method can proceed from stage 426 to stage 430 where the check-in service 160 can delete the meeting request. For example, the check-in agent 140 can remove the meeting request from the display of the user device B 120, and the check-in service 160 can remove the meeting request from the queue. In one example, this can be done without notifying the User A. In another example, the User B can choose whether to notify the User A. In still another example, the User B can include a response with the rejection, such as an explanation for why the meeting request was rejected, and the check-in service 160 can send a notification of the rejection that includes the User B's response.

Other examples of the disclosure will be apparent to those skilled in the art from consideration of the specification and practice of the examples disclosed herein. Though some of the described methods have been presented as a series of steps, it should be appreciated that one or more steps can occur simultaneously, in an overlapping fashion, or in a different order. The order of steps presented are only illustrative of the possibilities and those steps can be executed or performed in any suitable fashion. Moreover, the various features of the examples described here are not mutually exclusive. Rather any feature of any example described here can be incorporated into any other suitable example. It is intended that the specification and examples be considered as exemplary only, with a true scope and spirit of the disclosure being indicated by the following claims.

What is claimed is:

1. A method for providing a smart check-in service, comprising:
receiving, from a first user device, a meeting request for a meeting with a user of a second user device at a location;
adding the meeting request to a queue associated with the user;
receiving an indication that the user is at the location;
sending, to the second user device, the meeting request from the queue based on the indication that the user is at the location;
receiving, from the second user device, a response to the meeting request; and
in an instance where the response accepts the meeting request, sending, to the first user device, a notification that the meeting request was accepted.

2. The method of claim 1, further comprising:
in an instance where the response rejects the meeting request, deleting the meeting request.

3. The method of claim 1, further comprising:
in an instance where the response postpones the meeting request, adding the meeting request back to the queue.

4. The method of claim 1, wherein receiving the meeting request includes:
receiving text from a message sent to the user; and
identifying the meeting request in the text using a natural language processing technique.

5. The method of claim 1, wherein the indication that the user is at the location is based on location information associated with the second user device.

6. The method of claim 1, wherein the location information includes at least one of global positioning system information from the second user device, the second user device connecting to a local network at the location, and BLUETOOTH discovery information indicating that the second user device is at the location.

7. The method of claim 1, wherein the meeting request includes an urgency level associated with the meeting request.

8. A non-transitory, computer-readable medium containing instructions that are executed by a hardware-based processor to perform stages for providing a smart check-in service, the stages comprising:
receiving, from a first user device, a meeting request for a meeting with a user of a second user device at a location;
adding the meeting request to a queue associated with the user;
receiving an indication that the user is at the location;
sending, to the second user device, the meeting request from the queue based on the indication that the user is at the location
receiving, from the second user device, a response to the meeting request; and
in an instance where the response accepts the meeting request, sending, to the first user device, a notification that the meeting request was accepted.

9. The non-transitory, computer-readable medium of claim 8, the stages further comprising:
in an instance where the response rejects the meeting request, deleting the meeting request.

10. The non-transitory, computer-readable medium of claim 8, the stages further comprising:
in an instance where the response postpones the meeting request, adding the meeting request back to the queue.

11. The non-transitory, computer-readable medium of claim 8, wherein receiving the meeting request includes:
receiving text from a message sent to the user; and
identifying the meeting request in the text using a natural language processing technique.

12. The non-transitory, computer-readable medium of claim 8, wherein the indication that the user is at the location is based on location information associated with the second user device.

13. The non-transitory, computer-readable medium of claim 8, wherein the location information includes at least one of global positioning system information from the second user device, the second user device connecting to a local network at the location, and BLUETOOTH discovery information indicating that the second user device is at the location.

14. The non-transitory, computer-readable medium of claim 8, wherein the meeting request includes an urgency level associated with the meeting request.

15. A system for providing a smart check-in service, comprising:
a memory storage including a non-transitory, computer-readable medium comprising instructions; and
a computing device including a hardware-based processor that executes the instructions to carry out stages comprising:
receiving, from a first user device, a meeting request for a meeting with a user of a second user device at a location;
adding the meeting request to a queue associated with the user;
receiving an indication that the user is at the location;
sending, to the second user device, the meeting request from the queue based on the indication that the user is at the location
receiving, from the second user device, a response to the meeting request; and
in an instance where the response accepts the meeting request, sending, to the first user device, a notification that the meeting request was accepted.

16. The system of claim 15, the stages further comprising:
in an instance where the response rejects the meeting request, deleting the meeting request.

17. The system of claim 15, the stages further comprising:
in an instance where the response postpones the meeting request, adding the meeting request back to the queue.

18. The system of claim 15, wherein receiving the meeting request includes:
receiving text from a message sent to the user; and
identifying the meeting request in the text using a natural language processing technique.

19. The system of claim 15, wherein the indication that the user is at the location is based on location information associated with the second user device.

20. The system of claim 15, wherein the location information includes at least one of global positioning system information from the second user device, the second user device connecting to a local network at the location, and BLUETOOTH discovery information indicating that the second user device is at the location.
